(19) United States
(12) Patent Application Publication
(10) Pub. No.: US 2025/0362394 A1
(43) Pub. Date: Nov. 27, 2025

(54) RANGING DEVICE

(71) Applicant: SONY SEMICONDUCTOR SOLUTIONS CORPORATION, Kanagawa (JP)

(72) Inventor: Yutaro YAMASHITA, Kanagawa (JP)

(21) Appl. No.: 18/867,964

(22) PCT Filed: May 17, 2023
(86) PCT No.: PCT/JP2023/018460

§ 371 Date: Nov. 21, 2024

(30) Foreign Application Priority Data
May 31, 2022 (JP) 2022-089035

(51) Int. Cl. G01S 7/4865; G01S 7/481; G01S 7/484; G01S 7/4863; G01S 7/497; G01S 17/10; G01S 17/931

(52) U.S. Cl. CPC G01S 7/4866; G01S 7/4815; G01S 7/484; G01S 7/4863; G01S 7/497; G01S 17/10; G01S 17/931

(57) ABSTRACT

[Object]

To increase ranging accuracy.

[Solving Means]

Provided is a ranging device (1) including a light emitting element array (102), a light receiving element array (126), a control circuit (120), a histogram generation circuit (128), a processing circuit (130), and storage circuits (122, 140). The light emitting element array (102) includes light emitting elements that project light to a subject and are disposed in a one-dimensional or two-dimensional array form. The light receiving element array (126) includes light receiving elements that receive reflected light from the subject and are disposed in a one-dimensional or two-dimensional array form. The control circuit (120) controls a light emitting timing of the light emitting element and an exposure timing of the light receiving element. The histogram generation circuit (128) generates a histogram relating to information concerning light reception by the light receiving element. The processing circuit (130) measures a distance to the subject in reference to the histogram. The storage circuits (122, 140) store calibration information. The histogram generation circuit (128) generates, in reference to the calibration information, the histogram obtained by calibrating the information concerning light reception, for each light receiving element of the light receiving element array (126).

### TECHNICAL FIELD

The present disclosure relates to a ranging device.

### BACKGROUND ART

In a ranging device which emits light and receives reflected light, a vertical cavity surface emitting laser (VCSEL) is sometimes used. For example, in a solid-state LiDAR of one-dimensional or two-dimensional scan type which uses, as a transmitter which emits light, a one-dimensional or two-dimensional laser diode array (for example, a VCSEL array) and, as a receiver which receives reflected light, a one-dimensional or two-dimensional photo detector array (for example, a SPAD array) and has parallax between the transmission and the reception, there exists such a case in which, after a trigger signal is applied to the transmitter, a light emitting timing of each channel deviates from one another. In such a case, there is such a problem that, in the pixels on the receiver side on which a boundary between channels deviating from each other forms an image, the histograms are dispersed, resulting in deterioration of ranging accuracy.

### CITATION LIST

### Patent Literature

[PTL 1]
   JP 2021-513087T

### SUMMARY

### Technical Problem

In view of the above-mentioned problem, the present disclosure provides a ranging device which increases accuracy.

### Solution to Problem

According to one embodiment, a ranging device includes a light emitting element array, a light receiving element array, a control circuit, a histogram generation circuit, a processing circuit, and a storage circuit. The light emitting element array includes light emitting elements that project light to a subject and are disposed in a one-dimensional or two-dimensional array form. The light receiving element array includes light receiving elements that receive reflected light from the subject and are disposed in a one-dimensional or two-dimensional array form. The control circuit controls a light emitting timing of the light emitting element and an exposure timing of the light receiving element. The histogram generation circuit generates a histogram relating to information concerning light reception by the light receiving element. The processing circuit measures a distance to the subject in reference to the histogram. The storage circuit stores calibration information. In the ranging device, the histogram generation circuit generates, in reference to the calibration information, the histogram obtained by calibrating the information concerning light reception, for each light receiving element of the light receiving element array.

The storage circuit may include a register, and the control circuit may write, in reference to the calibration information, to the register, delay information relating to the histogram for each light receiving element in the light receiving element array.

The histogram generation circuit may shift the information concerning light reception for each light receiving element, in reference to the delay information written to the register, and may generate the histogram in reference to the shifted information concerning light reception.

The processing circuit may calculate the distance from the histogram according to parallax between the light emitting element and the light receiving element that receives the light output from the light emitting element.

The calibration information may include information based on a delay of the light emitting timing of the light emitting element.

The calibration information may include information based on a delay of the light receiving timing of the light receiving element.

The calibration information may be set in advance in reference to information measured through use of the light emitting element array and the light receiving element array.

The calibration information may be determined in reference to information measured by disposing the subject at a predetermined calibration distance, and receiving, by the light receiving element array, the light emitted from the light emitting element array and then reflected by the subject.

The calibration information may be determined on the basis of information measured by disposing the subject at a distance at which a light receiving region deviates, by an amount of one pixel, from a position corresponding to the predetermined calibration distance in the light receiving element array, and receiving, by the light receiving element array, the light emitted from the light emitting element array and then reflected by the subject.

The storage circuit may further include a data sheet storage section that stores the calibration information as a data sheet.

Moreover, according to one embodiment, a ranging device includes a light emitting element array, a light receiving element array, a control circuit, a histogram generation circuit, a processing circuit, and a storage circuit. The light emitting element array includes light emitting elements that project light to a subject and are disposed in a one-dimensional or two-dimensional array form. The light receiving element array includes light receiving elements that receive reflected light from the subject and are disposed in a one-dimensional or two-dimensional array form. The control circuit controls a light emitting timing of the light emitting element and an exposure timing of the light receiving element. The histogram generation circuit generates a histogram relating to information concerning light reception by the light receiving element. The processing circuit measures a distance to the subject in reference to the histogram. The storage circuit stores calibration information. The histogram generation circuit acquires delay information relating to each light receiving element based on a data sheet set in advance, and generates the histogram obtained by calibrating the information concerning light reception, for each light receiving element.

### BRIEF DESCRIPTION OF DRAWINGS

FIG. 1 is a diagram for illustrating an example of disposition of a light emitting element and a light receiving element.

FIG. 2A is a diagram for illustrating timings of light emission in a light emitting element array and exposure in a light receiving element array according to an embodiment.

FIG. 2B is a diagram for illustrating the timings of the light emission in the light emitting element array and the exposure in the light receiving element array according to the embodiment.

FIG. 2C is a diagram for illustrating the timings of the light emission in the light emitting element array and the exposure in the light receiving element array according to the embodiment.

FIG. 2D is a diagram for illustrating the timings of the light emission in the light emitting element array and the exposure in the light receiving element array according to the embodiment.

FIG. 2E is a diagram for illustrating the timings of the light emission in the light emitting element array and the exposure in the light receiving element array according to the embodiment.

FIG. 2F is a diagram for illustrating the timings of the light emission in the light emitting element array and the exposure in the light receiving element array according to the embodiment.

FIG. 2G is a diagram for illustrating the timings of the light emission in the light emitting element array and the exposure in the light receiving element array according to the embodiment.

FIG. 2H is a diagram for illustrating the timings of the light emission in the light emitting element array and the exposure in the light receiving element array according to the embodiment.

FIG. 3A is a diagram for illustrating the timings of the light emission in the light emitting element array and the exposure in the light receiving element array according to the embodiment.

FIG. 3B is a diagram for illustrating the timings of the light emission in the light emitting element array and the exposure in the light receiving element array according to the embodiment.

FIG. 3C is a diagram for illustrating the timings of the light emission in the light emitting element array and the exposure in the light receiving element array according to the embodiment.

FIG. 3D is a diagram for illustrating the timings of the light emission in the light emitting element array and the exposure in the light receiving element array according to the embodiment.

FIG. 3E is a diagram for illustrating the timings of the light emission in the light emitting element array and the exposure in the light receiving element array according to the embodiment.

FIG. 3F is a diagram for illustrating the timings of the light emission in the light emitting element array and the exposure in the light receiving element array according to the embodiment.

FIG. 3G is a diagram for illustrating the timings of the light emission in the light emitting element array and the exposure in the light receiving element array according to the embodiment.

FIG. 3H is a diagram for illustrating the timings of the light emission in the light emitting element array and the exposure in the light receiving element array according to the embodiment.

FIG. 4 is a block diagram for illustrating an overview of a ranging device according to the embodiment.

FIG. 5 is a timing chart according to the embodiment.

FIG. 6 is a diagram for illustrating the example of disposition of the light emitting element array and the light receiving element array according to the embodiment.

FIG. 7 is a graph for illustrating histograms of light receiving timings according to the embodiment.

FIG. 8 is a diagram for illustrating an example of the disposition of the light emitting element array and the light receiving element array according to the embodiment.

FIG. 9 is a graph for illustrating the histograms of the light receiving timings according to the embodiment.

FIG. 10 is a graph for illustrating the histograms of the light receiving timings according to the embodiment.

FIG. 11 is a graph for illustrating the histograms of the light receiving timings according to the embodiment.

FIG. 12 is a flowchart for illustrating processing of delay measurement according to the embodiment.

FIG. 13 is a graph for illustrating the histograms in the processing of the delay measurement according to the embodiment.

FIG. 14 is a diagram of a circuit for the delay measurement of the light emitting element according to the embodiment.

FIG. 15 is a diagram of a circuit for the delay measurement of the light receiving element according to the embodiment.

FIG. 16 is a table for illustrating an example of a data sheet according to the embodiment.

FIG. 17 is a table for illustrating an example of the data sheet according to the embodiment.

FIG. 18 is a block diagram depicting an example of schematic configuration of a vehicle control system.

FIG. 19 is a diagram of assistance in explaining an example of installation positions of an outside-vehicle information detecting section and an imaging section.

### DESCRIPTION OF EMBODIMENT

A description is now given of an embodiment according to the present disclosure with reference to the drawings. The drawings are used for the description, and hence, it is not required that a shape, a size, an angle, a ratio in size and a distance to another configuration, and the like of a configuration of each section in the actual device are as illustrated. Moreover, the drawings are simplified, and hence, it is assumed that configurations required for installation are appropriately provided in addition to the illustrated configurations. Further, while a path of light and the like are sometimes illustrated in drawings, these drawings are illustrated for the convenience of visual understanding, and it should be understood that such a phenomenon as a reflection angle does not necessarily represent a physically accurate state.

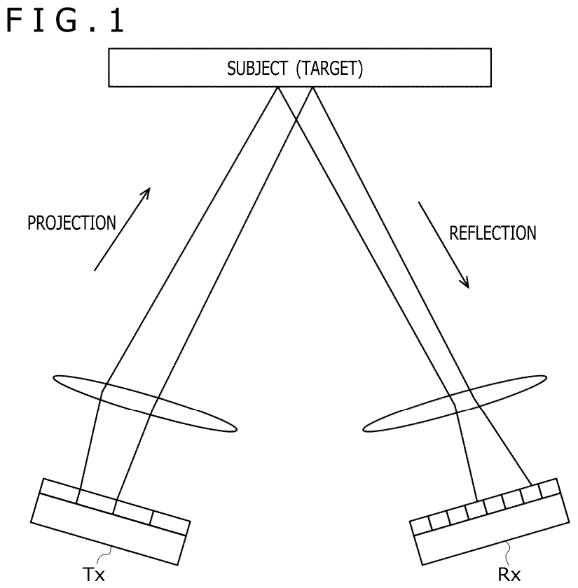

FIG. 1 is a diagram for illustrating an example of disposition of a light emitting element and a light receiving element in a solid-state LiDAR. The light emitting elements are disposed in a one-dimensional or two-dimensional array form in a light emitting element array of a light emitting section Tx. The light receiving elements are disposed in a one-dimensional or two-dimensional array form in a light receiving element array of a light receiving section Rx. Light emitted from the light receiving element is collected on a subject by an optical system, and the light reflected by the subject (target) is radiated to the light receiving element via the optical system. The subject indicates a target of the ranging.

The light emitting element is, for example, a vertical cavity surface emitting laser (VCSEL), and the light receiving element is, for example, a SPAD (Single Photon Avalanche Diode). The light emitting element and the light receiving element are not limited to them, and it is only required that the light emitting element and the light receiving element include a light emitting element which projects the light on the subject at appropriate intensity and a light receiving element which can appropriately acquire information relating to the reflected light from the subject, respectively.

As illustrated in the drawing, there may be employed such a form that the light emitted from one light emitting element is received by a plurality of light receiving elements. A light emitting timing of the light emitting element and an exposure timing for light reception in the light receiving element are linked as described below as a non-limiting example.

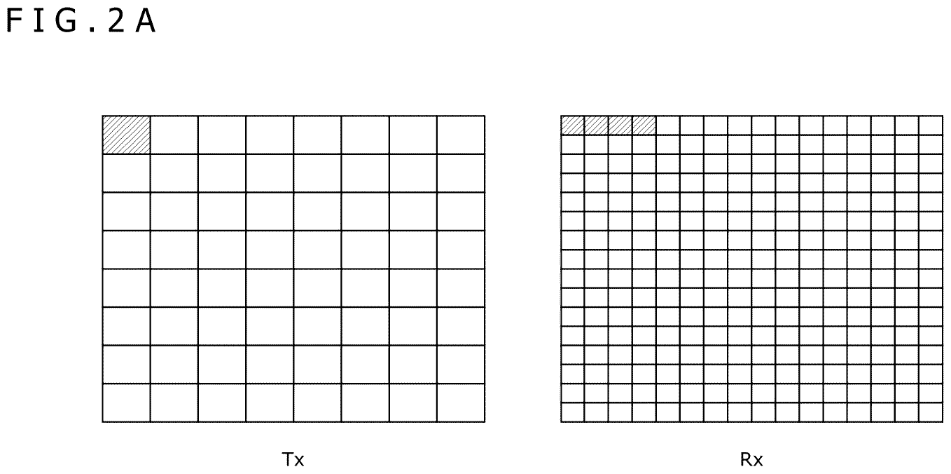

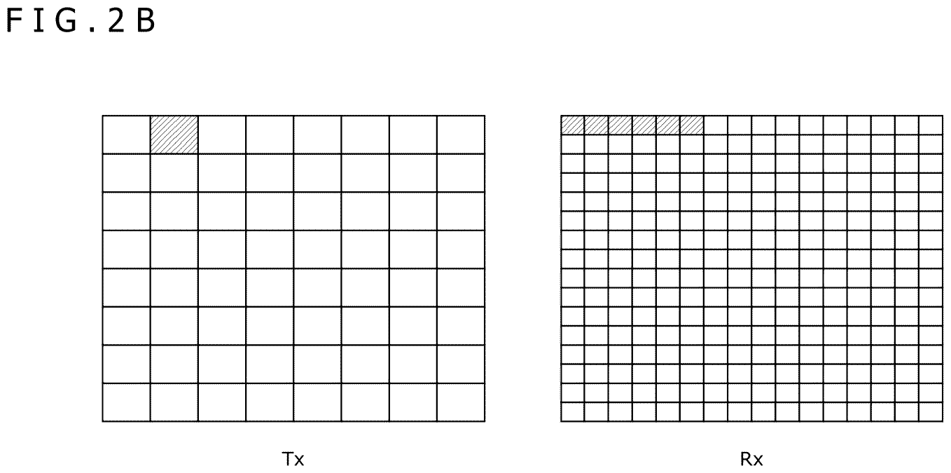

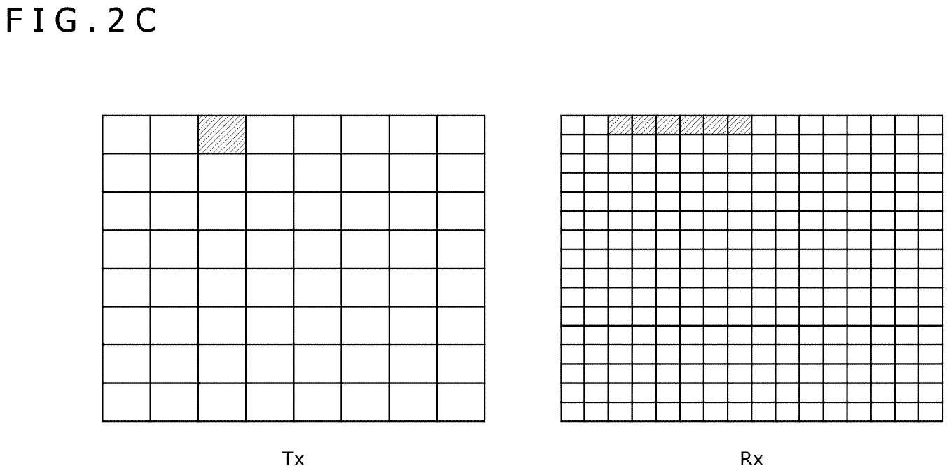

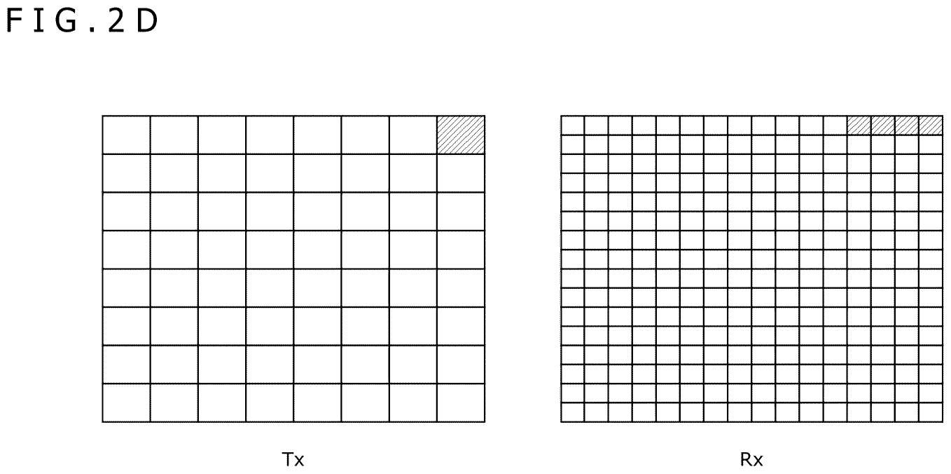

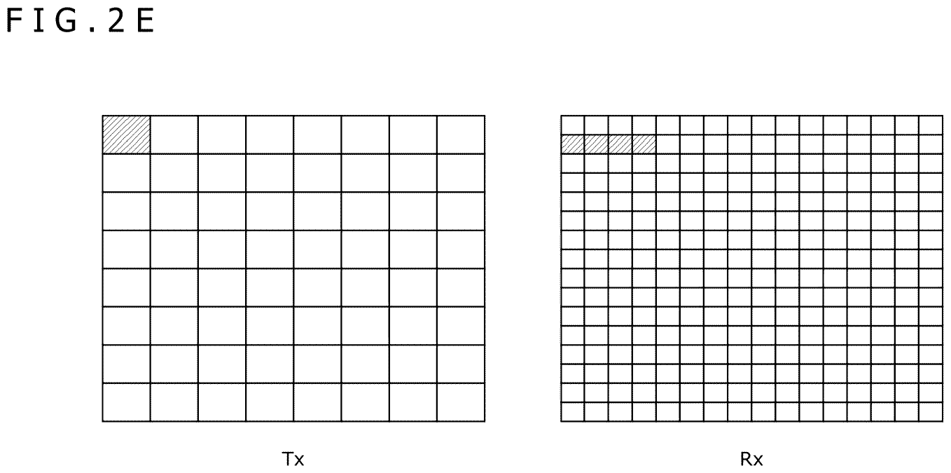

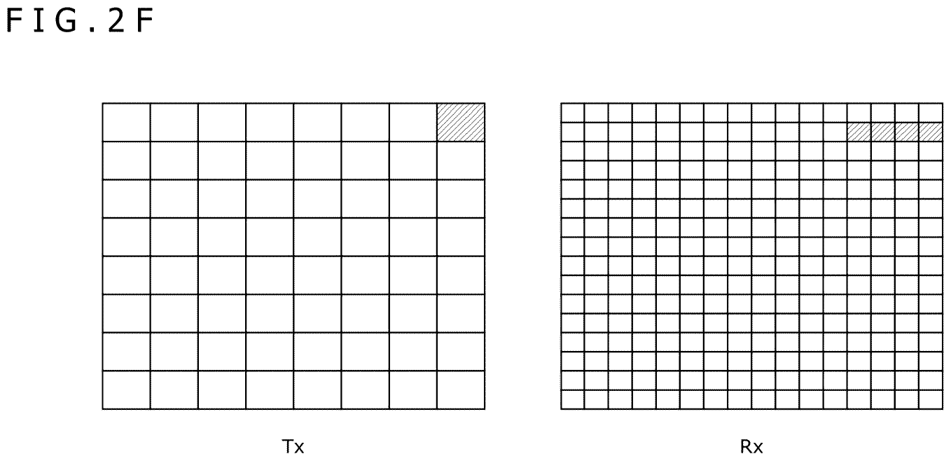

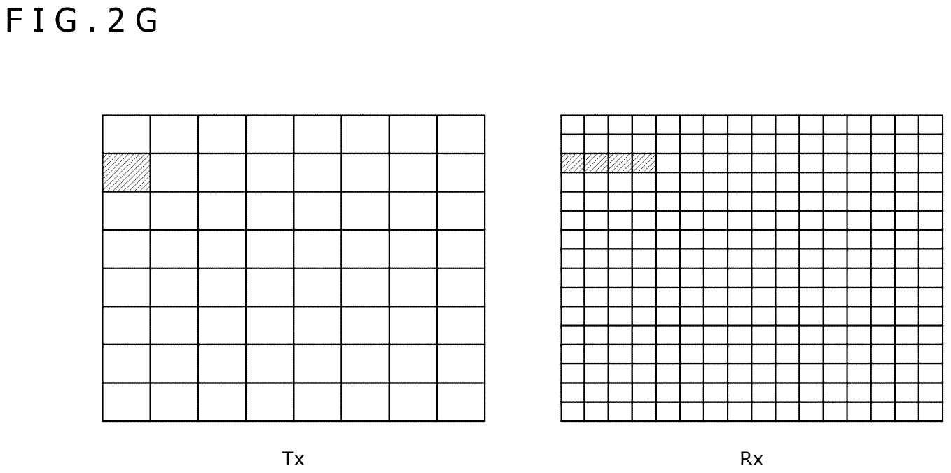

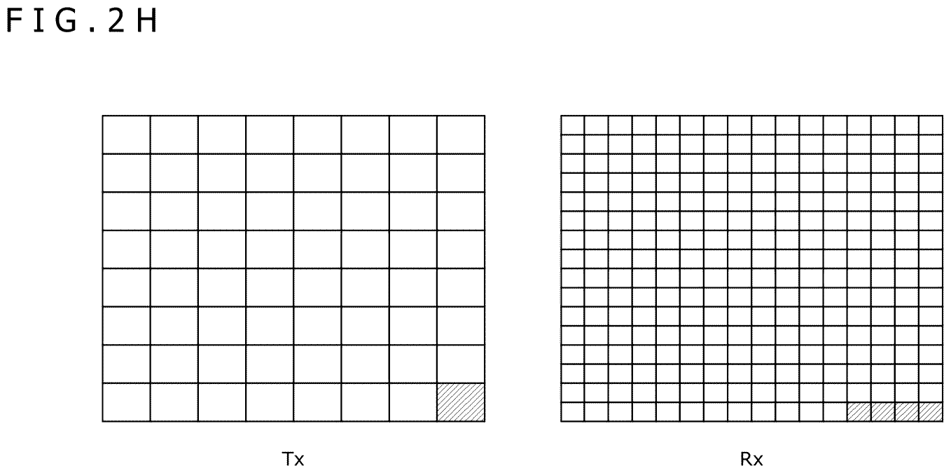

FIG. 2A to FIG. 2H are diagrams for illustrating examples of the light emitting timing of the light emitting element and the exposure timing of the light receiving elements matching this light emitting timing. The element emitting light in the light emitting element array and the elements exposed in the light receiving element array are indicated by hatching. Tx of the diagram denotes the light emitting element array, and Rx thereof denotes the light receiving element array. Further, the light emission of a pixel indicated by hatching in Tx is received by pixels indicated by hatching in Rx.

In these diagrams, the light emitting element array is provided with 8×8 light emitting elements, and the light receiving element array is provided with 16×16 light receiving elements, but these number of elements, a ratio in number of elements between the arrays, and the like are given as an example and are not limitative. Moreover, the first timing is set to an upper left position, and the last timing is set to a lower right position, but these timings are an example and are not limitative.

When scan starts, as illustrated in FIG. 2A, the upper left (hereinafter, such notation as (1,1) is used while the upper left position is set to a reference and denoted as (1,1), and the same applies to the light receiving element array) light emitting element emits light, and the light emitted from this light emitting element and is reflected on the subject is received through use of 4 light receiving elements at (1,1) to (4, 1) of the light receiving element array.

As described later, it is not required that the timing of the light emission and the timing of the exposure completely match each other, and, for example, the exposure timing may be started earlier than a light receiving timing and may be ended later than the light receiving timing in order receive light without fail while a sufficient margin is secured with respect to a previous light emitting timing.

Moreover, as illustrated, in order to permit a more or less deviation of the pixels in the light reception, for example, in the light receiving element array, the light receiving elements which are disposed along the light receiving elements corresponding to the light emitting element and correspond to one pixel of the light emitting element may be exposed at the same timing for redundant light reception. The number of such redundant pixels may be determined, for example, according to at least one of the optical system, the distance between the transmission section Tx and the light receiving section Rx, and an extent of the distance to be ranged.

At the next timing of this light reception, as illustrated in FIG. 2B, the light emission of the light emitting element at (2,1) is received through use of 6 light receiving elements at (1,1) to (6,1).

At the next timing, as illustrated in FIG. 2C, the light emission of the light emitting element at (3,1) is received through use of 6 light receiving elements at (3,1) to (8,1).

The light emitting element and the light receiving elements are shifted successively and are scanned in a line direction until, as illustrated in FIG. 2D, the light emission of the light emitting element at (8,1) is received through use of 4 light receiving elements at (13,1) to (16,1).

At the next timing, as illustrated in FIG. 2E, the light emission of the light emitting element at (1,1) is received through use of 4 light receiving elements at (1,2) to (4, 2). In a case in which the light receiving elements in the light receiving element array are denser than density of the light emitting elements in the light emitting element array as described above, the light emitting elements belonging to one line may emit light for the light reception in the light receiving elements on two lines.

As in the first line of the light receiving elements, the scan is repeated while the light emitting element and the light receiving elements are changed until, as illustrated in FIG. 2F, the light emission of the light emitting element at (1,8) is received through use of 4 light receiving elements at (13,2) to (16,2).

After that, at the next timing after the light reception for two lines as illustrated in FIG. 2F, the light emission of the light emitting element at (2,1) is received through use of 4 light receiving elements at (1, 3) to (4, 3) as illustrated in FIG. 2G. As described above, the scan is similarly executed line by line for the second and subsequent lines of the light emitting elements and for the third and subsequent lines of the light receiving elements.

Finally, as illustrated in FIG. 2H, the light emission of the light emitting element at (8,8) is received through use of 4 light receiving elements at (13,16) to (16,16).

Processing for one frame is completed from FIG. 2A to FIG. 2H, and, after that, the light reception and the light emission are repeated in the next frame according to the timings from FIG. 2A.

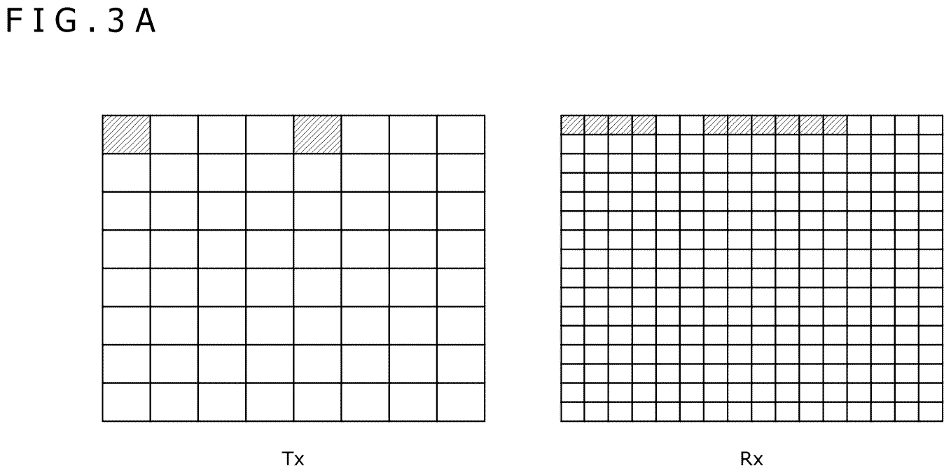

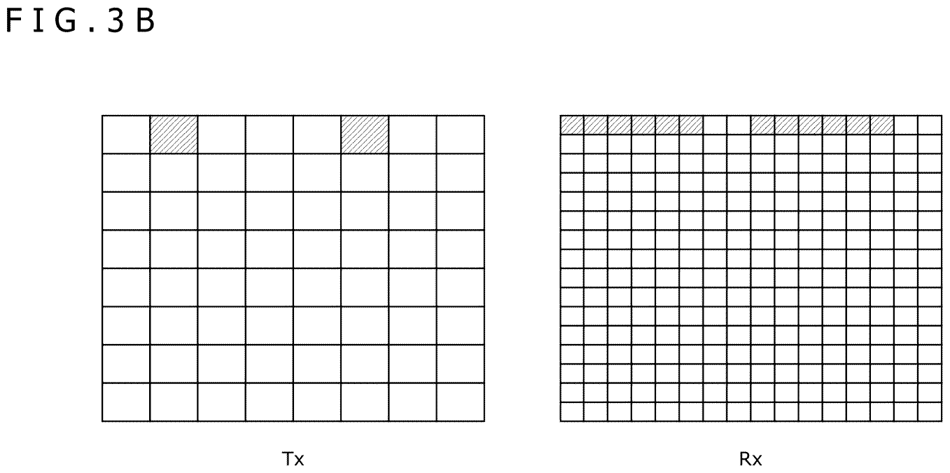

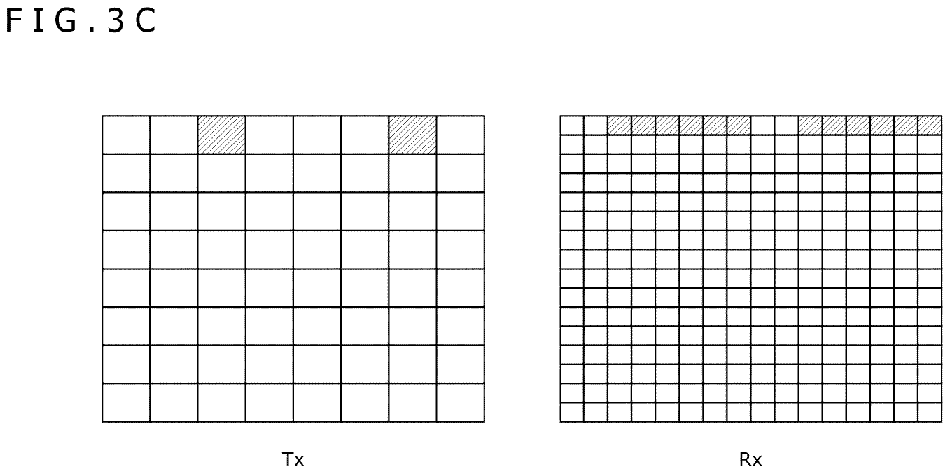

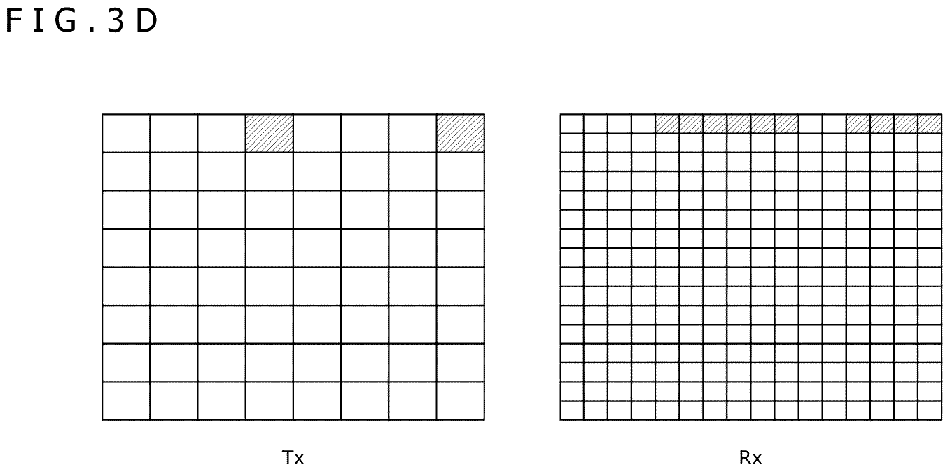

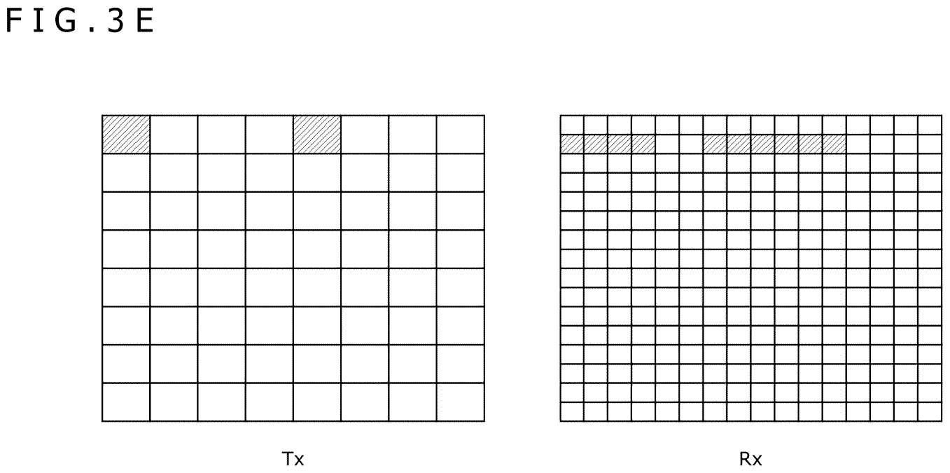

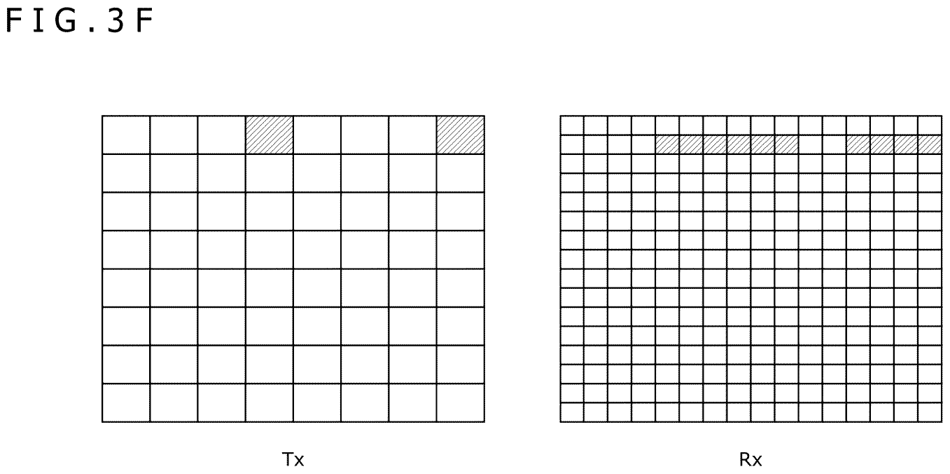

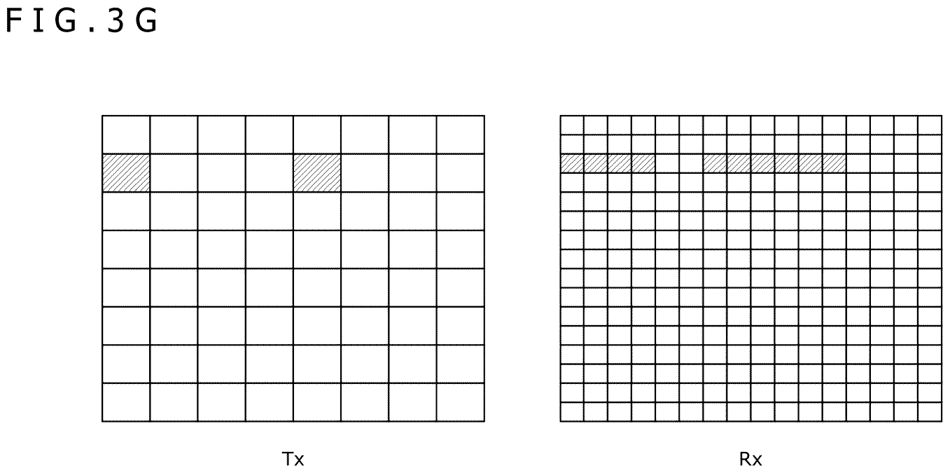

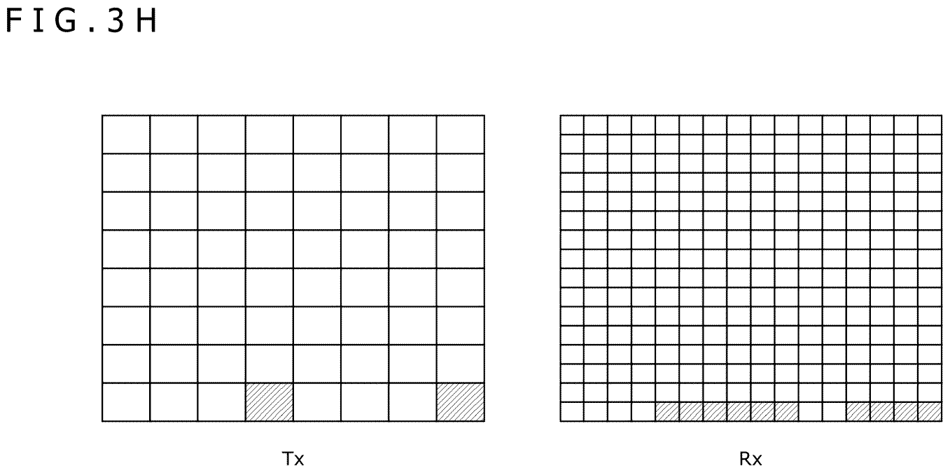

The light reception and the light emission are not limited to the configuration in which the light emission from one element is received. For example, as illustrated in FIG. 3A to FIG. 3H, the light emission from two light emitting elements may be received by two regions of the light receiving elements.

For example, as illustrated in FIG. 3A, the light emitting timing and the exposure timing may be set to such a timing that the light emission in the light emitting element at (1,1) is received by the 4 light receiving elements at (1,1) to (1, 4) and the light emission in the light emitting element at (5,1) is received by six light receiving elements at (7,1) to (12,1).

Also in this case, similarly, at the next timing, as illustrated in FIG. 3B, the light emitting timing of the light emitting element at (1,2) and the exposure timing of the six light receiving elements at (1,1) to (6,1) match each other, and the light emitting timing of the light emitting element at (6,1) and the exposure timing of six light receiving elements at (9,1) to (14, 1) match each other.

At the next timing, the light emitting timing and the light receiving timing are set as illustrated in FIG. 3C, and, at the second next timing, the timings are set as illustrated in FIG. 3D. As in the case of FIG. 2, at the next timing of FIG. 3D, the line of the light receiving elements is moved to the next line, the scan is executed along the line from a state of FIG. 3E, and the light emission and the light reception of FIG. 3F are executed.

After the scan along the line from FIG. 3E to FIG. 3F is completed, as illustrated in FIG. 3G, the line of the light receiving elements and the line of the light emitting elements are caused to transition to next lines, and the light emission and the light reception are similarly executed.

In the final state of the frame, as illustrated in FIG. 3H, the light emitting timings and the exposure timings are set such that the light emission in the light emitting element at (4, 8) is received by six light receiving elements at (5,16) to (10,16) and the light emission in the light emitting element at (8,8) is received by 4 light receiving elements at (13,16) to (16,16).

The light emitting element may emit the light once or may emit the light a plurality of times at the timing of each of the diagrams.

The light receiving element to be exposed is at the same position in the array as that of the light emitting element emitting the light illustrated in the same diagram, but the configuration is not limited to this example. For example, the element which emits light in the light emitting element array and the element which is exposed in the light receiving element array may be at a position line-symmetrical about the center in the line direction or the column direction of the array or point-symmetrical about the center of the array.

That is, in each of FIGS. 2 and 3, the position of the light receiving element exposed in the light receiving section Rx may be a position line-symmetrical about the center line in the horizontal direction or the vertical direction or may be a position point-symmetrical about the center point of the array. In FIGS. 2 and 3, in order to easily understand the relation between the light emitting elements and the light receiving elements having overlap in timing between the light emission and the light reception, these elements are represented as the elements belonging to the same positions.

Moreover, instead of the light emission and the light reception being executed at the plurality of positions in the line direction as illustrated in FIG. 3, the light emission and the light reception may be executed at a plurality of positions in the column direction. Further, the light emission and the light reception at a plurality of positions displaced in both the line direction and the column direction may be executed. After that, the transition to the next frame is made, and the light emission and the light reception are executed at similar timings.

In the present disclosure, the ranging device expresses light receiving states in the light receiving element array as histograms at the light receiving timings and the light emitting timings illustrated as the examples in FIGS. 2 and 3 and executes the ranging in reference to these histograms. In this case, deviations of the light emitting timing and the light receiving timing due to various causes are calibrated at a timing of the generation of the histograms, to achieve highly accurate ranging.

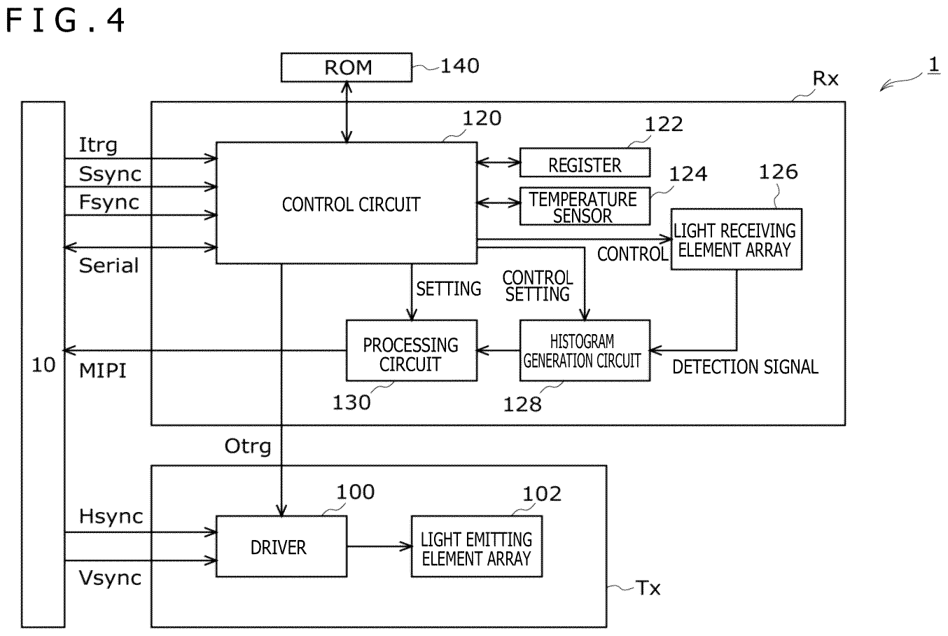

FIG. 4 is a block diagram for illustrating an overview of the ranging device according to the embodiment. A ranging device 1 includes, for example, a host 10, the light emitting section Tx, and the light receiving section Rx. The light emitting section Tx projects light to the subject in reference to a control signal from the host 10 and the light receiving section Rx receives the light reflected from the subject and measures the distance to the subject according to the light emitting timing and the light receiving timing. Moreover, the ranging device 1 internally or externally includes, as a part of a storage circuit, a ROM 140.

The host 10 executes transmission and reception of data to and from the light emitting section Tx and the light receiving section Rx and control thereof. The host 10 transmits, for example, to the light emitting section Tx, synchronization signals Hsync and Vsync and transmits, to the receiving section Rx, synchronization signals Ssync and Fsync and a trigger signal Itrg. The transmission and reception of the data to and from the receiving section Rx may be executed via, for example, MIPI (registered trademark) or a serial interface.

The light emitting section Tx including a driver 100 and a light emitting element array 102 projects light to the subject in reference to the synchronization signals transmitted from the host 10 and a trigger signal transmitted from the light receiving section Rx.

The driver 100 causes the light emitting element array 102 to emit the light at an appropriate timing in reference to the synchronization signals Hsync and Vsync received from the host 10 and the trigger signal Otrg received from the receiving section Rx.

The light emitting element array 102 includes light emitting elements, for example, VCSELs, in a one-dimensional or two-dimensional array form. Each of the light emitting elements emits light in reference to signals output from the driver 100.

As an example, the driver 100 controls, in reference to the synchronization signal Vsync in the vertical direction received from the host, timings of the start and the end of the frame in the light emitting element array 102, thereby bringing about a state in which light can be emitted. The driver 100 selectively specifies, in reference to the synchronization signal Hsync in the horizontal direction, the line in the light emitting element array 102, and executes light emitting drive control for the light emitting elements belonging to the line. In this state, the driver 100 outputs a signal for each column based on the trigger signal Otrg, and thereby causes the light emitting element disposed on the line selected by Hsync and on the specified column to emit the light at a timing of input of Otrg.

The light receiving section Rx includes a control circuit 120, a register 122, a temperature sensor 124, a light receiving element array 126, a histogram generation circuit 128, and a processing circuit 130. The light receiving section Rx brings an appropriate light receiving element into an exposure state in reference to the synchronization signals Ssync and Fsync input from the host 10 and the timing of the trigger signal Itrg, detects the reflected light, and measures the distance to the subject in reference to a detection result.

The control circuit 120 controls the light receiving elements disposed at appropriate positions or in an appropriate region in the light receiving element array 126, in reference to the synchronization signals Ssync and Fsync and the trigger signal Itrg received from the host 10. Moreover, the control circuit 120 transmits, on the basis of the trigger signal Itrg, to the driver 100 of the light emitting section Tx, the trigger signal Otrg for the light emitting element of the light emitting section Tx to emit the light such that the light receiving element can receive the reflected light in the exposed state.

The register 122 is provided as at least a part of the storage circuit and stores such calibration information that the exposure timing of the light receiving element and the light emitting timing of the light emitting element can appropriately be implemented. The calibration information is data for calibration in the histogram generation from the signal received in the light receiving element array 126. Details of the calibration information are described later.

The temperature sensor 124 measures a temperature in a housing and transmits temperature information to the control circuit 120 upon a request from the control circuit 120. This temperature information is used for, as an example, calibration processing based on the calibration information described above.

Note that the use of the temperature information for the calibration is not essential and hence may not be used. In this case, the temperature sensor 124 itself may not be provided in the ranging device 1.

The light receiving element array 126 includes light receiving elements, for example, SPADs, in a one-dimensional or two-dimensional array form. Each light receiving element is exposed according to the signals output from the control circuit 120, and receives the light projected from the light emitting element and then reflected on the subject. Each light receiving element disposed in the light receiving element array 126 outputs, to the histogram generation circuit 128, a detection signal indicating detection of the reflected light, at a timing of the light reception.

The histogram generation circuit 128 is a circuit which accumulates the timing of the light reception of the light receiving element and generates the histogram. The histogram generation circuit 128 generates the histogram by shifting the timing of the light reception of the light receiving element in reference to the calibration information output from the control circuit 120 and then accumulating the timing. The histogram generation circuit 128 generates, for example, a histogram having the time as a horizontal axis and an incident photon amount as a vertical axis for each light receiving element provided to the light receiving element array 126 and used for ranging.

The processing circuit 130 measures the distance to the subject in reference to the histograms generated by the histogram generation circuit 128. The processing circuit 130 measures the distance to the subject in consideration of, for example, the timing of the trigger signal Otrg output by the control circuit 120 for each light receiving element. The processing circuit 130 may transmit a ranging result to the host 10 via an interface, for example, the MIPI. The host 10 which has received the ranging result can use the ranging result for any processing.

The processing circuit 130 may measure the distance to the subject in reference to, for example, a mode value in the histogram generated for each light receiving element. The processing circuit 130 considers this mode value as the time from the emission of light to the reception by the light receiving element, and executes ranging. As a method of ranging from the time, in a case in which parallax does not exist, the processing circuit 130 may obtain the distance as ct/2 where “c” is the light speed and “t” is a time corresponding to the mode value.

In a case in which parallax exists, the processing circuit 130 can calculate the distance with use of “t” through a general method based on the parallax. As an example, in a case in which the parallax between the light receiving element and the light emitting element is represented as a distance D between the light receiving element and the light emitting element, the distance is given as a distance d=(c²t²−D²)/(2×(ct−D cos φ)) by using a light receiving angle φ of the reflected light from the subject. The method for obtaining the distance in the case in which the parallax exists is not limited to this example, and may be another appropriately defined method.

The ROM 140 is implemented as a part of the storage circuit and is provided, for example, outside or inside the receiving section Rx. Moreover, as another example, the ROM 140 may be provided outside the ranging device 1. As an example, the ROM 140 may be implemented by a Flash ROM or the like. In this ROM 140, a data sheet used for the calibration information may be stored. That is, the ROM 140 can operate as a data sheet storage section to which the calibration information is registered.

The histogram generation circuit 128 acquires, from the control circuit 120, the calibration information, for example, determined on the basis of a situation and read from the ROM 140 in the register 122, to acquire delay information relating to each light receiving element and the like and thereby calibrate the histogram.

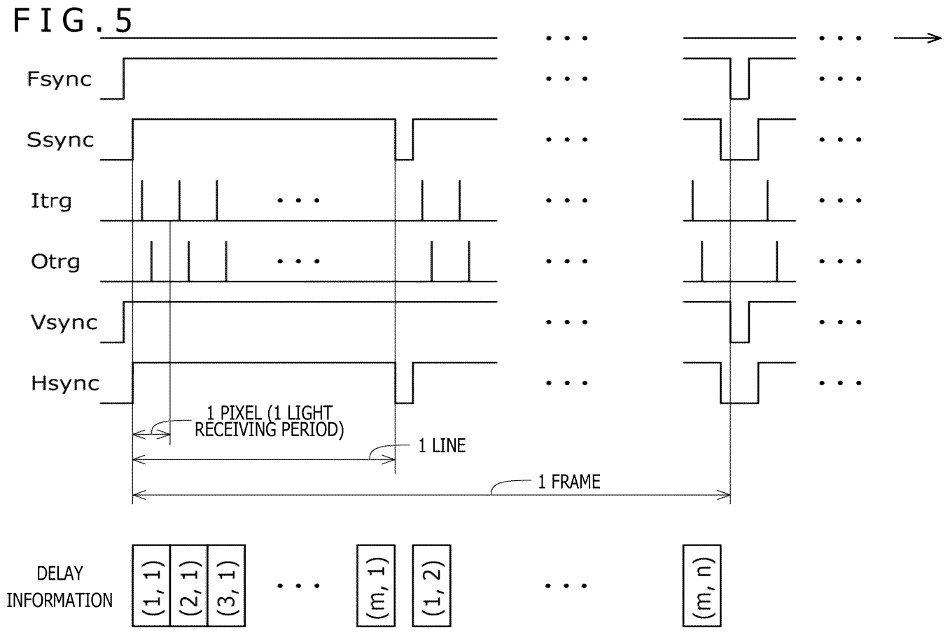

FIG. 5 is a timing chart of signal transmission and reception described above. The timing chart indicates Fsync, Ssync, Itrg, Otrg, Vsync, Hsync, and the delay information used for the calibration from the top in this sequence. A description is hereinafter given on an assumption that the number of light emitting elements included in the light emitting element array 102 is m×n pixels. As an example, “m” is the number of columns of the light emitting elements in the light emitting element array 102, and “n” is the number of lines of the light emitting elements in the light emitting element array 102.

Fsync is the synchronization signal in the vertical direction of the light receiving element array 126, and the signal is inverted at timings of the start and the end of the frame. For example, Fsync is a signal which turns on at the start of the frame and turns off at the end of the frame.

Ssync is the synchronization signal in the horizontal direction of the light receiving element array 126, and the signal is inverted at timings of the start and the end of the line to be scanned. For example, Ssync is a signal which turns on at the start timing of the line scan and turns off at the end timing of the line scan. Ssync includes the “n” times of ON periods in, for example, a period in which the Fsync is ON.

Itrg is a trigger signal being a pulse wave indicating the timing of the exposure start of the light receiving element, and the light receiving element which has received Itrg remains in the state in which the light can be received for a predetermined period from the timing of the reception. Notification of Itrg is performed for the “m” times at timings each at which Ssync is turned on. Notification of Itrg is performed for the light receiving elements disposed in the line and the columns selected in the light receiving element array 126. The example of the notified light receiving elements is illustrated in FIGS. 2 and 3. The selection of the light receiving elements is determined in association with the light emitting elements which emit light at the same timing.

This predetermined period is a sufficient length of time from the light emission of the light emitting element to the arrival of the light reflected on the subject at the light receiving elements and is a period which is completed at a timing before the timing of the next light emitting element, preferably the timing of the exposure start of the next light receiving elements. This end timing of the predetermined period may be, as an example, the timing of the end of the one pixel (one light receiving period) illustrated in the timing chart, a timing earlier than the timing of this end, or a timing before the input of Itrg in the next light receiving period.

Otrg is the trigger signal being a pulse wave indicating the light emitting timing of the light emitting element, and the light emitting element which has received Otrg emits the light once or a plurality of times at the timing of the reception. Notification of Otrg is performed at a timing simultaneous with the notification of Itrg or a timing a minute time after the notification of Itrg. This minute time may be determined in consideration of a time from the notification of Itrg to the light receiving element to the start of the exposure.

Notification of Otrg is performed for the same number of times as the notification of Itrg. That is, Otrg is issued for the “m” times at a timing at which Ssync is turned on. Notification of Otrg is performed for the light emitting element disposed in the line and the column selected in the light emitting element array 102. The light emitting element which receives the notification emits light according to the timing of the reception of Otrg.

The light emitted by the light emitting element is projected to the subject, and the light reflected on the subject is received by the light receiving element in the exposed state. The light receiving element which has received the light outputs, as the detection signal, the detection of the reflected light to the histogram generation circuit 128.

The histogram generation circuit 128 generates the histogram by shifting (delaying) the detection signal acquired from the light receiving element, in reference to the delay information acquired from the control circuit 120 and set for each light receiving element.

The delay information is illustrated on the lowest row of the timing chart. The register 122 stores, for example, in each one light receiving period, the delay information based on the calibration information acquired by the control circuit 120 from the ROM 140. The control circuit 120 reads, for each light emitting element, the delay information from the register 122.

The control circuit 120 reads, from the register 122, the delay information corresponding to the light emitting element which emits light in one light receiving period and outputs the read delay information to the histogram generation circuit 128. For example, at the first light receiving timing, the light emitted by the light emitting element disposed at (1,1) can be received by the light receiving elements, and delay information (1,1) corresponding to this light emitting element is set. In a state in which the light receiving period is switched and the exposure state of the light receiving elements is switched, this delay information is switched to delay information corresponding to the next light emitting element.

The histogram generation circuit 128 generates an appropriate histogram by appropriately shifting the timing of the detection signal in reference to the delay information set for each light emitting element and accumulating the shifted timing. Note that, as illustrated in FIGS. 2 and 3, the plurality of light receiving elements are sometimes simultaneously in the state in which the light can be received. In such a case, the histogram generation circuit 128 appropriately shifts the timing of the detection signal acquired from each of the plurality of light receiving elements, and generates the histograms.

Note that the histogram generation circuit 128 acquires the delay information from the control circuit 120, but the configuration is not limited to this example. For example, after the control circuit 120 acquires the delay information from the data stored in the ROM 140 and stores the delay information in the register 122, the histogram generation circuit 128 may directly refer to the register 122 and acquire the delay information.

Moreover, it is assumed that the delay information is read from the register for each light receiving element in the description given above, but the configuration is not limited to this example. As another example, the control circuit 120 may read, from the register, the delay information corresponding to the position of the light emitting element and output the delay information to the histogram generation circuit 128, and the histogram generation circuit 128 may shift the timing on the basis of this delay information, accumulate the shifted timing, and generate the histogram.

The timings of the light emission and the light reception in the present disclosure have been described above. A more specific description is now given of how the histogram is generated. For the convenience of description, the light emitting element array is represented as a 1×4 array, and the light receiving element array is represented as 1×8 array, but the configuration is not limited to these examples. Moreover, the description is given on an assumption that the light emitting element array includes light emitting elements A, B, C, and D, the light receiving element array includes light receiving elements “a,” “b,” “c,” “d,” “e,” “f,” “g,” and “h,” and the light emitting element B has a delay in the light emission.

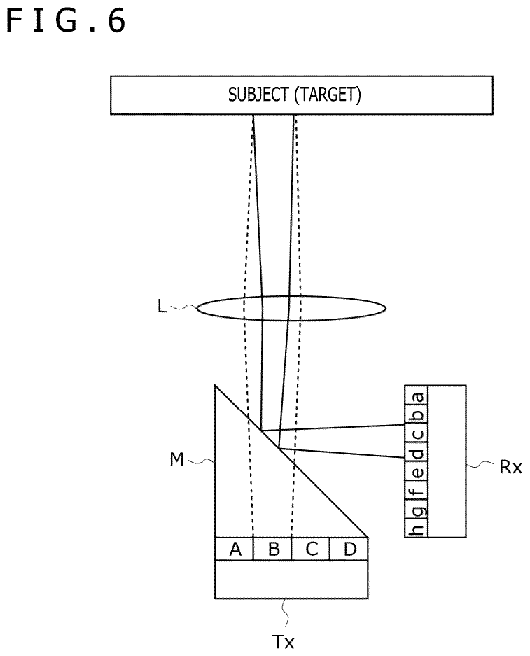

FIG. 6 is a diagram for illustrating a form including the light emitting element array and the light receiving element array having the same optical axis. For example, the light emitting element array and the light receiving element array are disposed to have an angle difference of 90 degrees, and a half mirror M is installed on a light emitting surface side of the light emitting element array such that the light reflected from the subject appropriately enters the light receiving element array. The light emitted from the light emitting element is projected on the subject via an optical system L, and this projected light is reflected on the subject, passes again through the optical system L, and is at least partially reflected toward the light receiving element array side by a surface of the half mirror M.

Dotted lines indicate the light emitted by the light emitting element B until it hits the subject, and solid lines indicate the light reflected from the subject until it is incident on the light receiving elements. Note that light that is reflected by the half mirror M and does not relate to the light received by the light receiving elements does not have particular influence, and hence, illustration thereof is omitted.

In this case, the parallax does not exist between the light emitting element array and the light receiving element array. Thus, in principle, the light emitted by each light emitting element is received by determined light receiving elements. For example, the light emitted by the light emitting element B is received by the light receiving elements “c” and “d.”

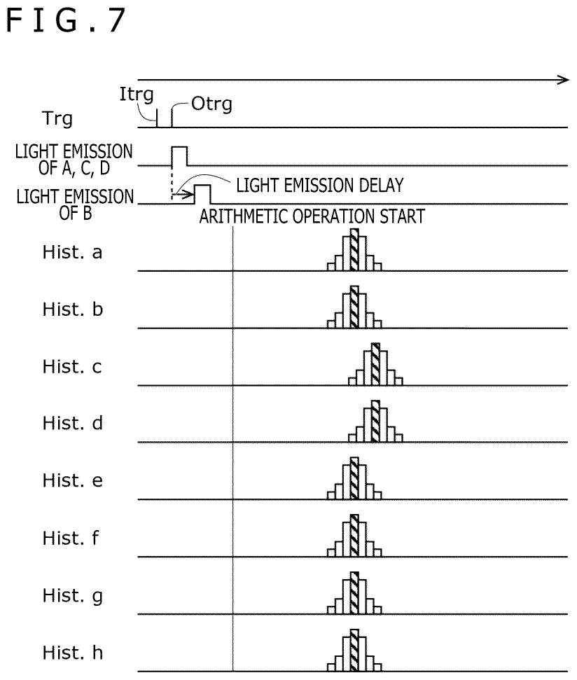

FIG. 7 is a diagram obtained by combining the histograms at the light receiving timing in the situation of FIG. 6 and a timing chart. The light receiving elements start the exposure at the timing of Itrg, and the light emitting elements emit light at the timing of Otrg. The light emitting elements A, C, and D emit the light at an appropriate timing at which Otrg is input. Meanwhile, the light emitting element B has a delay from the other channels due to, for example, defeat in war and the like. This delay is indicated by an arrow.

“Hist. a” is a histogram indicating the timing of the light detected by the light receiving element “a” in a state without the calibration, “Hist. b” is a histogram indicating the timing of the light detected by the light receiving element “b” in a state without the calibration, and following this, “Hist. c” to “Hist. h” are each similarly a histogram indicating the timing of the light detected by each of the light receiving elements “c” to “h” respectively in a state without the calibration.

In the histogram, a bin indicated by hatching represents the mode of the histogram. That is, the processing circuit 130 calculates the distance to the subject in reference to a difference between the time corresponding to the bin indicated by this hatching and an accumulation start time and the timing of Otrg.

In the case in which the emitted light from the light emitting element B is received by the light receiving elements “c” and “d” as illustrated in FIG. 6, the histograms themselves are deviated by the light emission delay of the light emitting element B from the histograms based on the detection signals output from the other light receiving elements as illustrated in FIG. 7.

Thus, in the case in which the light emitting element array and the light receiving element array are coaxial as illustrated in FIG. 6, the histogram generation circuit 128 can generate histograms by shifting the histograms obtained through reception of light in the period of the light emission of the light emitting element B having the delay by this delay amount and thereby generate appropriate histograms, and hence the ranging accuracy can be increased.

A description is now given of a case in which the light emitting element array and the light receiving element array are not coaxial and have parallax.

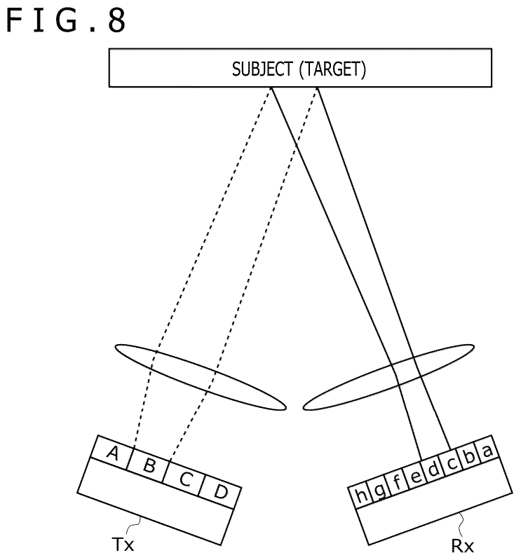

FIG. 8 is a diagram for illustrating a form including the light emitting element array and the light receiving element array having parallax. In such a case, for example, the histograms are deteriorated in various patterns depending on the distance to the subject to be ranged.

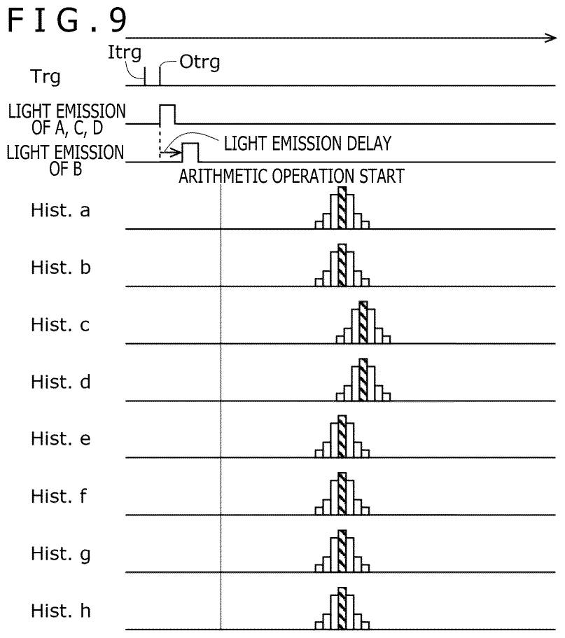

FIG. 9 is a diagram for illustrating the histograms in a case in which light is received by the light receiving elements “c” and “d” ideally corresponding to the light emitting element B. In this case, substantially similarly to those in FIG. 7, the histograms of the light receiving elements “c” and “d” are displaced by the delay amount of the light receiving element B.

In the state of FIG. 8, when the distance is deviated, there sometimes occurs such a case in which the reflected light of the light emitted by the light emitting element B is detected by not the light receiving elements “c” and “d”, but, for example, the light receiving elements “b” and “c.”

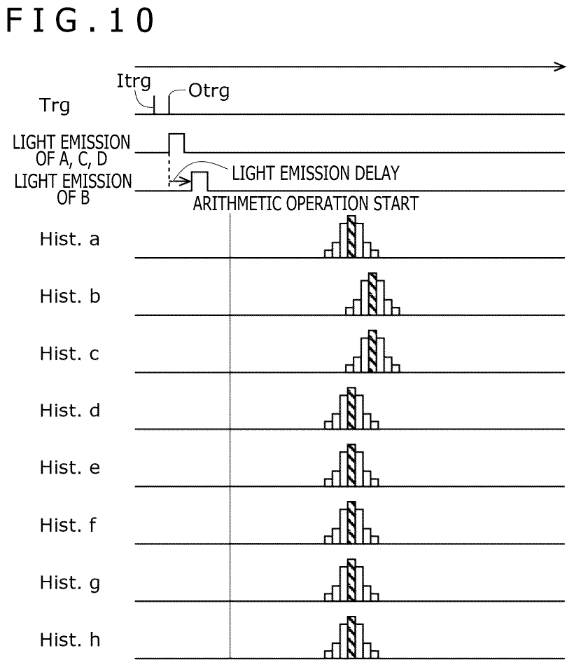

FIG. 10 illustrates a case in which the light is received by the light receiving elements deviated by the amount of one pixel as described above. In this case, the histograms of the light receiving elements “b” and “c” are deviated by the delay amount of the light receiving element B.

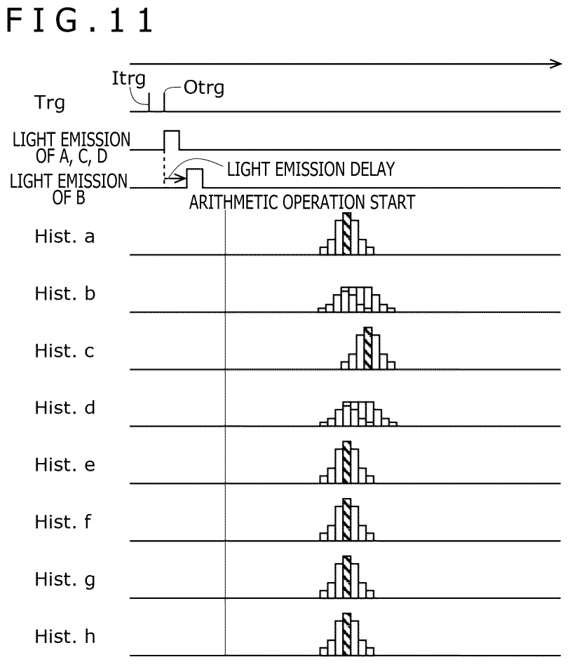

FIG. 11 is a diagram for illustrating an example of the histograms before the calibration not in the state in which the deviation is an integer number of pixels, which is described above. For example, FIG. 11 is a diagram for illustrating an example of the histograms before the calibration, in a case in which the light emitted by the light emitting element B is received in a state in which the deviation from the ideal state is 0.5 pixels. As illustrated in this diagram, the light emitted from the light emitting element B is received by the light receiving elements “b,” “c,” and “d.”

In the cases of FIG. 6 and FIG. 7 in which the arrays have the same optical axis, it is only required to execute the shift of the pixels determined independently of the distance to the subject. However, the distance to the subject is unknown, and hence, the pixels to be shifted cannot be determined even in the cases of FIG. 9 and FIG. 10. Moreover, in the case of FIG. 11, the appropriate calibration cannot be executed only by simply shifting the histograms at certain light receiving elements as described above.

Meanwhile, as described above, the histogram generation circuit 128 can generate the appropriate histograms by shifting the light receiving timing of each of the exposed light receiving elements at the timing of the light emission of the light emitting element B and accumulating the timing.

In the description given above, the case in which the light emitting element B has the delay is described as an example, but even in a case in which delays are occurring to a plurality of light emitting elements, the calibration can appropriately be made for each light emitting element at the timing of the generation of the histogram by writing the delay information in the register for each light receiving element as in the present disclosure.

Moreover, as another example, the delays from a reference time may be measured for all of the light emitting elements, and these delays and the reference time may be used to generate appropriate histograms with respect to the reference time.

In the description given above, the case in which the delay is occurring to the light emitting element is described, but the delay is not limited to this example. Through use of a similar method, even in a case in which a delay is occurring to the light receiving element, appropriate calibration for the histogram can be executed. In a case in which the delay is occurring to the light receiving element, the histogram generation circuit 128 can generate the appropriate histogram by shifting the detection signal from this light receiving element by the delay amount and then accumulating the shifted signal.

In a case in which a delay exists in one or more of light emitting elements and light receiving elements, the histogram generation circuit 128 can generate an appropriate histogram by combining the method for the case in which the delay exists in the light emitting element and the method for the case in which the delay exists in the light receiving element described above.

A description is now given of a method of acquiring appropriate calibration information. For example, this calibration information can be generated, in the case in which a delay exists in at least one of the light emitting elements or the light receiving elements, by acquiring the delay information relating to this light emitting element.

The calibration information is set in advance in reference to delay information measured through use of the light emitting element array and the light receiving element array.

As a non-limiting example, the ranging device 1 may be used to measure the delay.

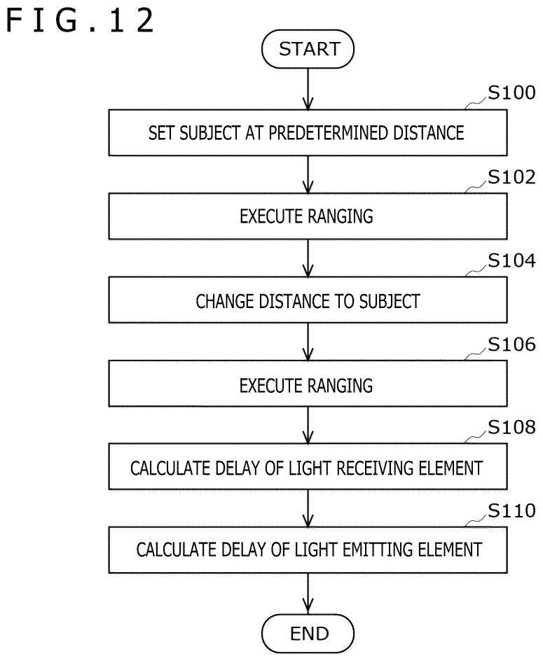

FIG. 12 is a flowchart for illustrating processing for the delay measurement through use of the ranging device 1 according to the embodiment. As an example, a description is now given of a case in which a delay exists in each of the light emitting element B and the light receiving element “f.”

First, as illustrated in FIG. 8 and the like, the subject is set to a position at a predetermined distance from the ranging device 1 (S100). This predetermined distance is ideally a distance at which the light emitting elements and the light receiving elements are associated with each other. For example, the predetermined distance is such a distance that the light emitted from the light emitting element B is reflected on the subject and appropriately enters the light receiving elements “c” and “d.” This distance is set to a calibration distance (d_{calib}). This processing in S100 is executed by, for example, disposing a uniformly equal distant chart as a subject at a predetermined distance from the ranging device 1.

In this state, the ranging device 1 executes the ranging in the state without the calibration and generates a histogram indicating the detection timing at each light receiving element (S102).

After that, the subject is moved to such a distance (d_{calib+1}) that the light emitted by each light emitting element of the light emitting element array deviates by the amount of one pixel from the ideally corresponding light receiving element of the light receiving element array (S104).

In this state, the ranging device 1 executes the ranging in the state without the calibration and generates a histogram indicating the detection timing at each light receiving element (S106).

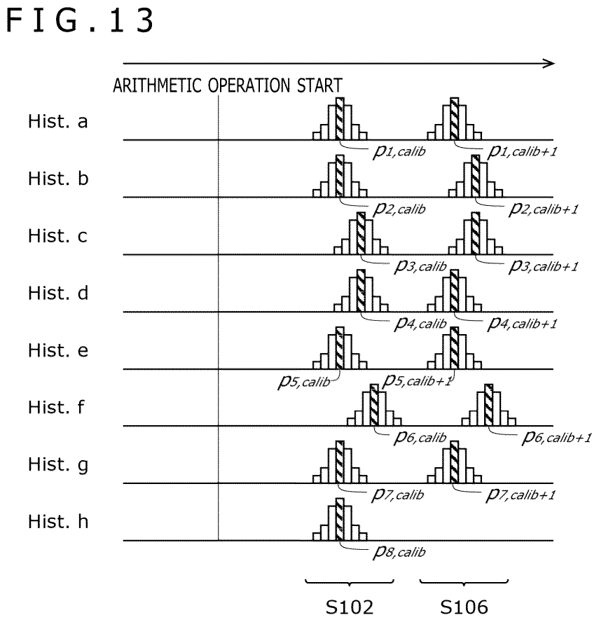

FIG. 13 is a diagram for illustrating an example of the histograms generated in S102 and S106. Of two histograms existing side by side, a left histogram is a histogram in S102, and a right histogram is a histogram in S106. As illustrated in this diagram, a position of the peak of the histogram generated for each light receiving element at each distance is denoted as P_{n,calib+x}.

As indicated by these histograms, the deviations of the histograms caused by the delay of the light emitting element B and the deviations of the histograms caused by the delay of the light receiving element “f” can visually be recognized. From positions of the peaks (times corresponding to bins constituting the peaks), the delays of the light receiving elements and the light emitting element are calculated as given by the following expressions.

First, the delay of the light receiving element is given by the following expression while the light receiving element “a” is set to a criterion (S108). Note that, for the convenience of representation of the expression, in order to match the representation of the position of the peak, numbers are used such that the delay of the light receiving element “b” is represented as Delay_{Rx,2}, the delay of the light receiving element “c” is represented as Delay_{Rx,3}, . . . , the delay of the light receiving element “h” is represented as Delay_{Rx,8}, and the like.

$$\begin{matrix}[ Math . 1 ] & \\ {Delay}_{Rx , i} = {\sum }_{l = 1}^{i - 1} ( {p}_{l + 1 , calib} - {p}_{l , calib + 1} - {d}_{calib + 1} + {d}_{calib} ) & ( 1 )\end{matrix}$$

The delay Delay_{Tx,j} of the light emitting element is given by the following expression (S110). Note that the number of the light emitting element is 1/k of the number of the light receiving elements and, for example, in FIGS. 2 and 3, k=2.

$$\begin{matrix}[ Math . 2 ] & \\ {Delay}_{Tx , j} = \frac{{\sum }_{l = jk}^{jk + k - 1} ( {p}_{l , calib} - {d}_{calib} - {Delay}_{Rx , l} )}{k} & ( 2 )\end{matrix}$$

The delay information acquired as described above is stored as the calibration information in the ROM 140. At the time of the ranging, the histogram generation circuit 128 can generate appropriate histograms by acquiring these pieces of delay information stored in the ROM 140.

Moreover, before the formation of the ranging device 1, the calibration information can also be acquired.

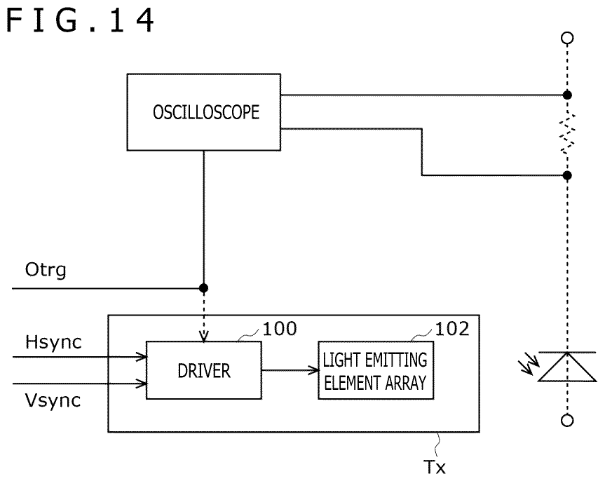

FIG. 14 is a diagram for illustrating a circuit which measures the delay of each light emitting element of the light emitting element array. On a path indicated as a dotted line, a delay is known.

The synchronization signals and the trigger signal are appropriately input to the driver 100, and each light emitting element of the light emitting element array 102 is caused to emit light. This light is received by the light receiving element. Further, a change in voltage at both ends of a resistor connected to this light receiving element is acquired by an oscilloscope, and the delay is acquired.

It is only required that the synchronization signals and the trigger signal are generated by an appropriate synchronization signal generation device.

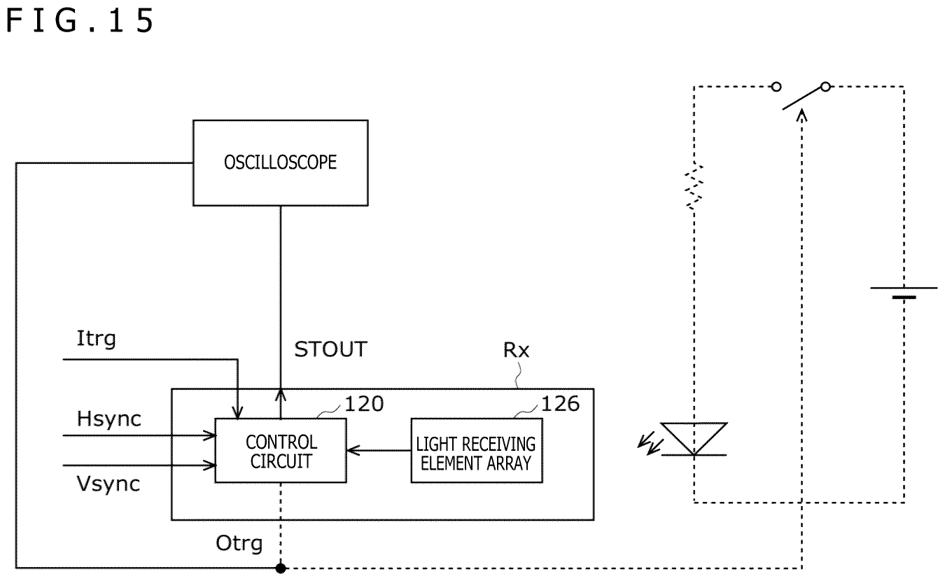

FIG. 15 is a diagram for illustrating a circuit which measures the delay of each light receiving element of the light receiving element array. On a path indicated as dotted lines, delays are known. That is, the light emitting element which emits light according to the timing of Otrg output by the control circuit 120 is used, and the light from this light emitting element is received by each light receiving element of the light receiving element array 126.

A difference in timing between the signal detected by the light receiving element and Otrg is acquired by an oscilloscope, so that the delay for each light receiving element can be measured.

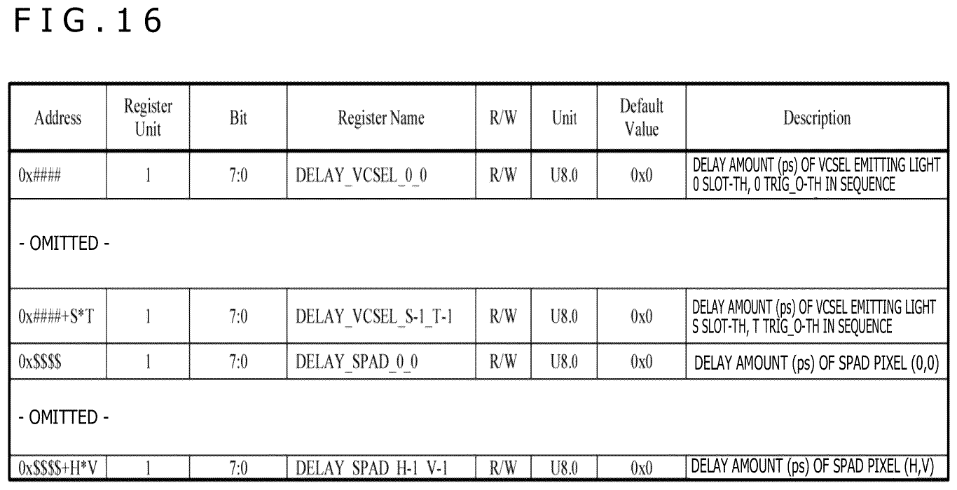

FIG. 16 is a table for illustrating an example of the data sheet storing the calibration information according to the embodiment. As illustrated in this table, addresses, register units for the registration, bit numbers, register names, R/W (writable/readable) flags, units, default values, and the like may be stored.

The control circuit 120 can reflect, at the timing of the histogram generation, appropriate delay information and the like from the various types of calibration information defined in advance, according to the situation, by reading the values from the data sheet and writing the values to the register.

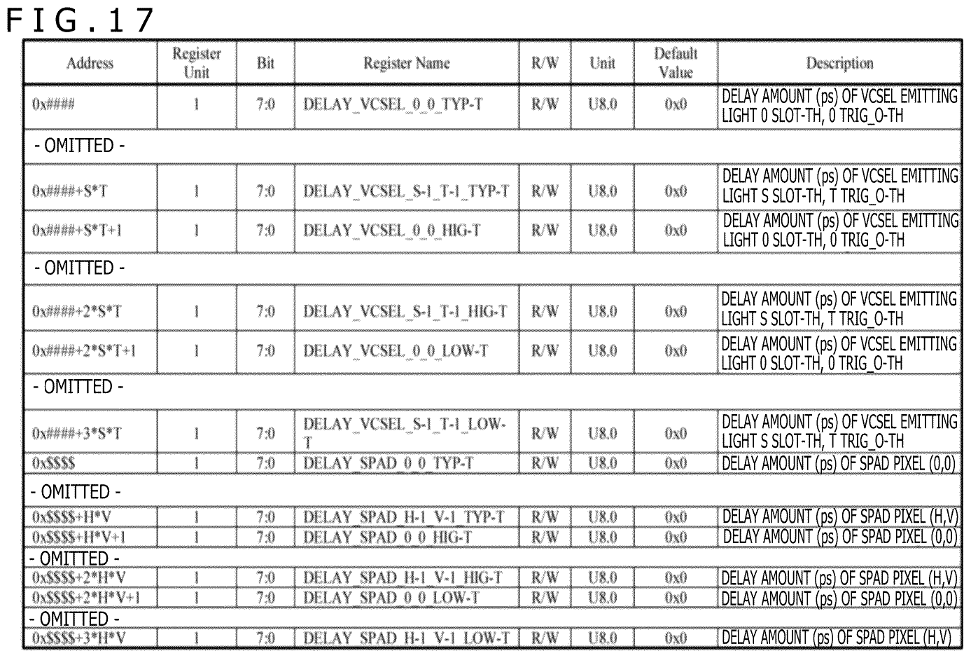

FIG. 17 is a table for illustrating an example of the data sheet storing the calibration information according to the embodiment. As illustrated in this table, as the calibration information, the temperature of the light receiving section Rx may be reflected.

In a delay timing, for example, there may be cases in which a temperature characteristic due to a capacitance change of a capacitor and the like exists. In such a case, it is possible to make correction according to the temperature. As a non-limiting example, as illustrated in FIG. 17, parameters of 3 types being typical temperature (_TYP-T), high temperature (HIG_T), and low temperature (LOW_T) are defined, and the parameter to be selected may be determined according to a measurement value of the temperature sensor 124 and may then be used.

For the determination of the typical temperature, the high temperature, and the low temperature, a high-temperature threshold value and a low-temperature threshold value may be set, and the determination may be made according to whether the measurement value of the temperature sensor 124 is between the high-temperature threshold value and the low-temperature threshold value, equal to or higher than the high-temperature threshold value, or equal to or lower than the low-temperature threshold value. As a result, it is possible to achieve robust calibration of the timing also for the temperature.

As described above, according to the present embodiment, the ranging accuracy can be increased by appropriately calibrating the histograms in terms of the various delays. The deviation of the drive timing difficult in adjustment when each of the light emitting section Tx and the light receiving section Rx exists alone can be calibrated by using this function to execute the calibration, and hence, even a variation due to an individual difference can be reduced. Even in a case in which a delay amount is unknown, for example, it is also possible to use the ranging device 1 to measure the delay amount as described above.

The technology according to the present disclosure can be applied to various products. For example, the technology according to the present disclosure may be embodied as a device mounted to a mobile body of any type such as a vehicle, an electric vehicle, a hybrid electric vehicle, a motor cycle, a bicycle, a personal mobility, an airplane, a drone, a vessel, a robot, a construction machine, and an agricultural machine (tractor).

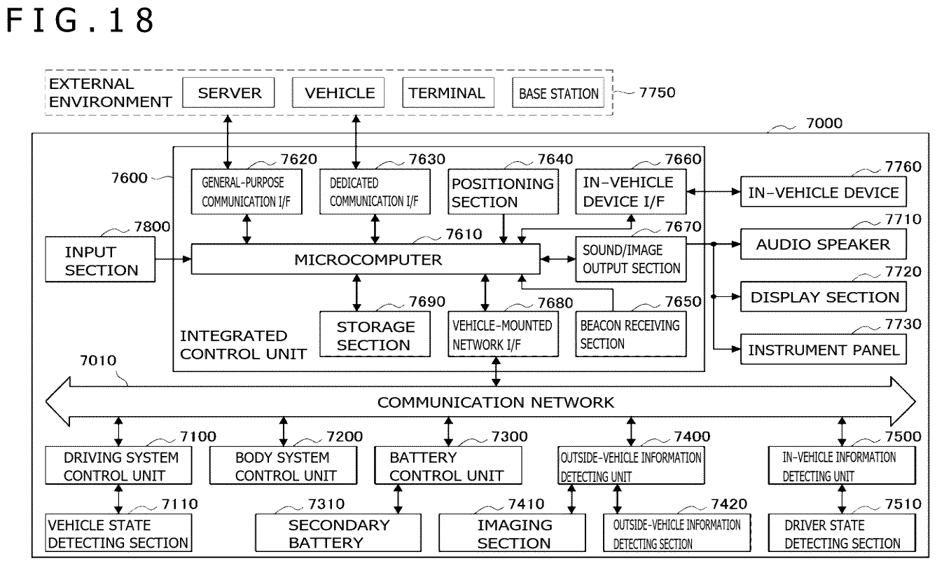

FIG. 18 is a block diagram depicting an example of schematic configuration of a vehicle control system 7000 as an example of a mobile body control system to which the technology according to an embodiment of the present disclosure can be applied. The vehicle control system 7000 includes a plurality of electronic control units connected to each other via a communication network 7010. In the example depicted in FIG. 18, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 18 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

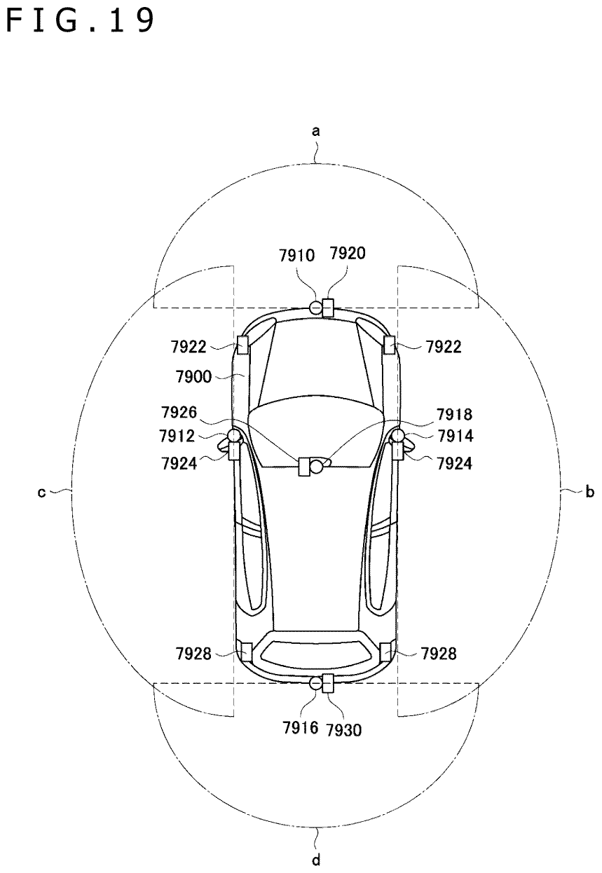

FIG. 19 depicts an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Incidentally, FIG. 19 depicts an example of photographing ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 18, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 18, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Incidentally, at least two control units connected to each other via the communication network 7010 in the example depicted in FIG. 18 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

In the vehicle control system 7000 described above, the ranging device 1 according to the present embodiment described above with reference to the drawings can be applied to the pottery control unit 7600 illustrated in FIG. 18.

Further, at least some of the components of the ranging device 1 described with reference to the drawings may be implemented in a module (for example, an integrated circuit module formed by one die) for the outside-vehicle information detecting unit 7400, the imaging section 7410, the outside-vehicle information detecting section 7420, or the positioning section 7640 illustrated in FIG. 18.

The embodiment described above may also be in the following forms.

(1)

A ranging device including:
a light emitting element array that includes light emitting elements that project light to a subject and are disposed in a one-dimensional or two-dimensional array form;
a light receiving element array that includes light receiving elements that receive reflected light from the subject and are disposed in a one-dimensional or two-dimensional array form;
a control circuit that controls a light emitting timing of the light emitting element and an exposure timing of the light receiving element;
a histogram generation circuit that generates a histogram relating to information concerning light reception by the light receiving element;
a processing circuit that measures a distance to the subject in reference to the histogram; and
a storage circuit that stores calibration information,
in which the histogram generation circuit generates, in reference to the calibration information, the histogram obtained by calibrating the information concerning light reception, for each light receiving element of the light receiving element array.
   (2)

The ranging device according to (1),
in which the storage circuit includes a register, and
the control circuit writes, in reference to the calibration information, to the register, delay information relating to the histogram for each light receiving element in the light receiving element array.
   (3)

The ranging device according to (2),
in which the histogram generation circuit
   shifts the information concerning light reception for each light receiving element, in reference to the delay information written to the register, and
   generates the histogram in reference to the shifted information concerning light reception.
      (4)

The ranging device according to any one of (1) through (3),
in which the processing circuit calculates the distance from the histogram according to parallax between the light emitting element and the light receiving element that receives the light output from the light emitting element.
   (5)

The ranging device according to any one of (1) through (4),
in which the calibration information includes information based on a delay of the light emitting timing of the light emitting element.
   (6)

The ranging device according to any one of (1) through (5),
in which the calibration information includes information based on a delay of the light receiving timing of the light receiving element.
   (7)

The ranging device according to any one of (1) through (6),
in which the calibration information is set in advance in reference to information measured through use of the light emitting element array and the light receiving element array.
   (8)

The ranging device according to (7),
in which the calibration information is determined in reference to information measured by
   disposing the subject at a predetermined calibration distance, and
   receiving, by the light receiving element array, the light emitted from the light emitting element array and then reflected by the subject.
      (9)

The ranging device according to (8),
in which the calibration information is determined in reference to information measured by
   disposing the subject at a distance at which a light receiving region deviates, by an amount of one pixel, from a position corresponding to the predetermined calibration distance in the light receiving element array, and
   receiving, by the light receiving element array, the light emitted from the light emitting element array and then reflected by the subject.
      (10)

The ranging device according to any one of (1) through (9),
in which the storage circuit further includes a data sheet storage section that stores the calibration information as a data sheet.
   (11)

A ranging device including:
a light emitting element array that includes light emitting elements that project light to a subject and are disposed in a one-dimensional or two-dimensional array form;
a light receiving element array that includes light receiving elements that receive reflected light from the subject and are disposed in a one-dimensional or two-dimensional array
a control circuit that controls a light emitting timing of the light emitting element and an exposure timing of the light receiving element;
a histogram generation circuit that generates a histogram relating to information concerning light reception by the light receiving element;
a processing circuit that measures a distance to the subject in reference to the histogram; and
a storage circuit that stores calibration information,
in which the histogram generation circuit
   acquires delay information relating to each light receiving element based on a data sheet set in advance, and
   generates a histogram obtained by calibrating the information concerning light reception, for each light receiving element.

The aspect of the present disclosure is not limited to the embodiment described before and includes various conceivable modifications, and the effects of the present disclosure are not limited to the content described above. The components in each embodiment may be appropriately combined and then applied. That is, within a range not departing from the conceptual idea and purport of the present disclosure derived from the contents and equivalents prescribed in the scope of claims, various additions, changes, and partial deletions can be made.

### REFERENCE SIGNS LIST

1: Ranging device
10: Host
Tx: Light emitting section
100: Driver
102: Light emitting element array
Rx: Light receiving section
120: Control circuit
122: Register
124: Temperature sensor
126: Light receiving element array
128: Histogram generation circuit
130: Processing circuit
140: ROM

What is claimed is:

1. A ranging device comprising:
a light emitting element array that includes light emitting elements that project light to a subject and are disposed in a one-dimensional or two-dimensional array form;
a light receiving element array that includes light receiving elements that receive reflected light from the subject and are disposed in a one-dimensional or two-dimensional array form;
a control circuit that controls a light emitting timing of the light emitting element and an exposure timing of the light receiving element;
a histogram generation circuit that generates a histogram relating to information concerning light reception by the light receiving element;
a processing circuit that measures a distance to the subject in reference to the histogram; and
a storage circuit that stores calibration information,
wherein the histogram generation circuit generates, in reference to the calibration information, the histogram obtained by calibrating the information concerning light reception, for each light receiving element of the light receiving element array.

2. The ranging device according to claim 1,
wherein the storage circuit includes a register, and
the control circuit writes, in reference to the calibration information, to the register, delay information relating to the histogram for each light receiving element in the light receiving element array.

3. The ranging device according to claim 2,
wherein the histogram generation circuit
shifts the information concerning light reception for each light receiving element, in reference to the delay information written to the register, and
generates the histogram in reference to the shifted information concerning light reception.

4. The ranging device according to claim 1,
wherein the processing circuit calculates the distance from the histogram according to parallax between the light emitting element and the light receiving element that receives the light output from the light emitting element.

5. The ranging device according to claim 1,
wherein the calibration information includes information based on a delay of the light emitting timing of the light emitting element.

6. The ranging device according to claim 1,
wherein the calibration information includes information based on a delay of the light receiving timing of the light receiving element.

7. The ranging device according to claim 1,
wherein the calibration information is set in advance in reference to information measured through use of the light emitting element array and the light receiving element array.

8. The ranging device according to claim 7,
wherein the calibration information is determined in reference to information measured by
disposing the subject at a predetermined calibration distance, and
receiving, by the light receiving element array, the light emitted from the light emitting element array and then reflected by the subject.

9. The ranging device according to claim 8,
wherein the calibration information is determined in reference to information measured by
disposing the subject at a distance at which a light receiving region deviates, by an amount of one pixel, from a position corresponding to the predetermined calibration distance in the light receiving element array, and
receiving, by the light receiving element array, the light emitted from the light emitting element array and then reflected by the subject.

10. The ranging device according to claim 1,
wherein the storage circuit further includes a data sheet storage section that stores the calibration information as a data sheet.

11. A ranging device comprising:
a light emitting element array that includes light emitting elements that project light to a subject and are disposed in a one-dimensional or two-dimensional array form;
a light receiving element array that includes light receiving elements that receive reflected light from the subject and are disposed in a one-dimensional or two-dimensional array form;
a control circuit that controls a light emitting timing of the light emitting element and an exposure timing of the light receiving element;
a histogram generation circuit that generates a histogram relating to information concerning light reception by the light receiving element;
a processing circuit that measures a distance to the subject in reference to the histogram; and
a storage circuit that stores calibration information,
wherein the histogram generation circuit
acquires delay information relating to each light receiving element based on a data sheet set in advance, and
generates the histogram obtained by calibrating the information concerning light reception, for each light receiving element.
